(19) United States
(12) Patent Application Publication
(10) Pub. No.: US 2015/0020645 A1
(43) Pub. Date: Jan. 22, 2015

(54) STARTER UNIT FOR A MOBILE DEVICE WITH AN INTERNAL COMBUSTION ENGINE

(71) Applicant: Andreas Reichart, Camberley (GB)

(72) Inventor: Andreas Reichart, Camberley (GB)

(21) Appl. No.: 14/332,563

(22) Filed: Jul. 16, 2014

(30) Foreign Application Priority Data
Jul. 18, 2013 (DE) 10 2013 011 978.2

(51) Int. Cl. F02N 5/02

(52) U.S. Cl. CPC F02N 5/02
USPC 74/7 C

(57) ABSTRACT

The starter unit comprising a starter shaft, a transmission, a clutch and a spring accumulator. The starter shaft is mounted in a longitudinally displaceable manner. The spring accumulator is adapted to act on the starter shaft for causing a rotational movement of the starter shaft. The starter shaft is arranged and adapted to be brought from a disengaged idle position into an engaged starter position cooperating with a clutch. The starter shaft is arranged such that it is mounted in a torque proof manner in the disengaged idle position and is rotatably mounted in the engaged starter position. The transmission is arranged and adapted to couple, on its output side, to the spring accumulator for at least partial charging thereof. The clutch is arranged and adapted to transmit, when the starter shaft is engaged, a rotational movement of the starter shaft caused by the spring accumulator to an engine shaft of the internal combustion engine in order to cause rotation thereof. In this starter unit, the starter shaft is arranged and adapted to be brought from the disengaged idle position into the engaged starter position by means of a longitudinal movement to be applied manually. For manual engagement in the starter position, the starter shaft comprises a push button which is rotatably accommodated at an end of the starter shaft facing away from the clutch. Thus, the potential energy stored in the spring accumulator can be provided for starting the internal combustion engine by pressing the button on the starter shaft. By pressing the button, the starter shaft is displaced, for example in its longitudinal direction, and is engaged in the engaged starter position in the clutch.

### CLAIM OF PRIORITY

This application claims the benefit of priority of German Patent Application Serial No. 10 2013 011 978.2, filed on Jul. 18, 2013, the benefit of priority of which is claimed hereby, and which is incorporated by reference herein in its entirety.

### DESCRIPTION

1. Background

A starter unit for a mobile device with an internal combustion engine is disclosed herein. In such mobile devices, for example a lawn mower or a chain saw, the starter conventionally has a rope pull device to be pulled by hand acting on a free-wheel clutch which is independent of rotational speed and connected to the engine shaft of the internal combustion engine. Actuation of this rope pull device is cumbersome and requires an amount of suppleness of the operator which is not automatically given, for example, in the case of elderly people. In particular, in the case of chain saws, which are also to be started by a user located on a ladder or in a treetop by means of the rope pull device, there is a high risk of accidents during starting.

Suggestions of alternative solutions are apparent, for example, from DE 20 2004 002 841 U1, GB 2 009 325 A, GB 2 160 931 A, or US 2004/0244754 A1. However, these suggestions are not very practicable, highly unsafe in handling and/or require external energy which is hard to introduce in a controlled dose.

DE 200 13 477 U1 relates to a mechanical starter for an internal combustion engine with a small capacity. This starter comprises a rechargeable mechanical energy accumulator which is recharged by the internal combustion engine. The energy accumulator is a spiral spring adapted with a square cross-section. Here, both discharge and recharge of the energy accumulator are controlled via a gear transmission and mechanical clutches and via mechanical actuating elements. In this starter, the energy accumulator can also be charged by means of a crank handle.

However, in the highly schematically disclosed arrangement of DE 200 13 477 U1, no information can be found that or how the above addressed aspects of ease of handling, safety of operation and ergonomics can be put into practice or are in fact implemented here. Rather, an “actuating element” is disclosed in the most general sense which is not specified any further even in the drawing. With respect to the actuating element, it is merely explained that a clutch is engaged by the actuating element for charging the spring accumulator. After the starting process, the clutch is again disengaged via the actuating element.

From EP 0 089 024 A1 disclosing the preamble of patent claim 1, a mechanical starter for an internal combustion engine is known, in which strips of elastomeric material are disposed between two coaxial disks rotatable relative to each other.

Also in this case, no information is disclosed how the arrangement is to be implemented to make it safe in operation, easy in handling and ergonomic.

Underlying Problem

Thus, a starter unit for a mobile device with an internal combustion engine is to be suggested which is easy to handle and can be operated with a minimum risk of accidents and a low amount of force.

Suggested Solution, Variants, Advantages, Characteristics

This problem is solved by the starter unit according to patent claim 1 suggested here.

The starter unit according to patent claim 1 comprises a starter shaft, a transmission, a clutch and a spring accumulator. The starter shaft is mounted in a longitudinally displaceable manner. The spring accumulator is adapted to act on the starter shaft for causing a rotational movement of the starter shaft. The starter shaft is arranged and adapted to be brought from a disengaged idle position into an engaged starter position cooperating with a clutch. The starter shaft is arranged such that it is mounted in a torque proof manner in the disengaged idle position and is rotatably mounted in the engaged starter position. The transmission is arranged and adapted to couple, on its output side, to the spring accumulator for at least partial charging thereof. The clutch is arranged and adapted to transmit, when the starter shaft is engaged, a rotational movement of the starter shaft caused by the spring accumulator to an engine shaft of the internal combustion engine in order to cause rotation thereof. In this starter unit, the starter shaft is arranged and adapted to be brought from the disengaged idle position into the engaged starter position by means of a longitudinal movement to be applied manually. For manual engagement in the starter position, the starter shaft comprises a push button which is rotatably accommodated at an end of the starter shaft facing away from the clutch. Thus, the potential energy stored in the spring accumulator can be provided for starting the internal combustion engine by pressing the button on the starter shaft. By pressing the button, the starter shaft is displaced, for example in its longitudinal direction, and is engaged in the engaged starter position in the clutch.

Contrary to the above mentioned arrangements, this starter unit does not require a drilling machine or such like having an electrical power supply of its own or a compressed air supply. It is easy to operate. The transmission of this starter unit can be configured such that, for example, a reduction of the introduced rotational movement enables charging of the spring accumulator also by weak persons. Thus, the required force can be easily provided by the operator. The starter unit suggested here is also hazard-free, since the conventional rope pull to be pulled out from a conventional starter by the operator can be omitted. Rather, the starter unit suggested here is to be accommodated in a closed housing, from which no rope pull of a length of approx. 1 m to 1.5 m is to be pulled out.

The dependence on available auxiliary energy sources (electrical energy, compressed air, etc.) is eliminated in this starter unit.

Furthermore, the starter unit suggested here can also be scaled to other sizes of internal combustion engines, since the size of the spring accumulator and the parameters of the transmission (transmission/reduction ratio, transmissible torque, etc.) can be determined simply depending on the internal combustion engine to be started.

Finally, the starter unit suggested here can be easily replaced or retrofitted in existing devices. Since the conventional rope-pull mechanisms are largely identical in construction and in function, the starter unit suggested here can be used for respective existing size ranges of existing gardening tools. For this purpose, the present rope-pull mechanism can be dismounted from the internal combustion engine and the starter unit suggested here can be mounted instead.

In a design variant, the transmission can be adapted to charge the spring accumulator in the disengaged idle position of the starter shaft only.

The transmission can be arranged and adapted to transmit a manual rotational movement to be applied on a transmission input side to the spring accumulator for charging the spring accumulator.

In a variant of the starter unit, the starter shaft, the transmission and the clutch can be arranged such that, when the starter shaft is engaged in the engaged starter position, the starter shaft is released from its torque-proof mounting only after the starter shaft has been engaged with the clutch.

In a variant of the starter unit, the clutch can be a centrifugal clutch adapted to accommodate the starter shaft in a torque proof manner when the starter shaft is engaged in the starter position, and to release the starter shaft when a rotational movement is applied to the centrifugal clutch by the internal combustion engine at a predetermined rotational speed.

The spring accumulator can comprise a spiral spring, wherein one end of the spring accumulator is to be coupled to the transmission and the other end of the spring accumulator is coupled to the starter shaft.

In a variant of the starter unit, a spring arrangement can be provided for forcing the starter shaft from the engaged starter position back into the disengaged idle position. Thus, the starter shaft can be prevented from remaining engaged in the clutch and being rotated by the internal combustion engine during operation thereof.

The transmission can be a reduction gear which translates a plurality of revolutions on its input side into an at least partial rotation of the end of the spring accumulator to be coupled to the transmission. However, it is also possible to transmit the rotational movements on the input side of the transmission to the spring accumulator in a ratio of 1:1.

In a variant of the starter unit, the transmission can comprise a blocking device which permits charging of the spring accumulator by rotating the input side of the transmission in a first rotation direction of rotation, but prevents rotation of the input side of the transmission in a second, opposite direction of rotation.

Finally, a mobile device with an internal combustion engine, such as a lawn mower or a chain saw, comprising a starter unit of the above describe type is suggested.

### BRIEF DESCRIPTION OF THE DRAWINGS

Further objects, features, advantages and possible applications are apparent from the following description of non-limiting embodiments with reference to the associated drawings. All described and/or graphically illustrated features, per se or in any combination, form the subject matter disclosed here, even independent of their grouping in the claims or the dependencies thereof. The dimensions and proportions of the components shown in the Figures are not necessarily to scale; they may deviate from what is illustrated here in embodiments to be implemented.

The above explained product, apparatus and method details are illustrated in context. However, it is pointed out that they are also independent of each other and can also be freely combined in each case.

FIG. 1 shows a variant of a starter unit in a lateral schematic sectional view in a disengaged idle position.

FIG. 2 shows a lateral sectional view through a starter shaft of the variant according to FIG. 1 along line A-A in a schematic top view.

FIG. 3 shows a lateral sectional view through a starter shaft of the variant according to FIG. 1 along line B-B in a schematic top view.

FIG. 4 shows a part of a transmission of the variant according to FIG. 1 in a schematic top view.

FIG. 5 shows a part of a blocking device of the transmission of the variant according to FIG. 1 in a schematic bottom view.

FIG. 6 shows a spring accumulator of the variant according to FIG. 1 in a schematic top view.

FIG. 7 shows the variant of a starter unit according to FIG. 1 in a lateral schematic sectional view in an engaged starter position.

FIG. 8 shows a clutch of a starter unit according to FIG. 1 in a schematic sectional view along line C-C.

FIG. 9 shows a clutch of a starter unit according to FIG. 1, when the clutch again releases the starter shaft, in a schematic side view.

### DETAILED DESCRIPTION OF THE DRAWINGS

The starter unit 10 suggested here is explained with reference to the Figures. A number of variants are possible which are not illustrated in detail in connection with the Figures, but are disclosed in the residual description.

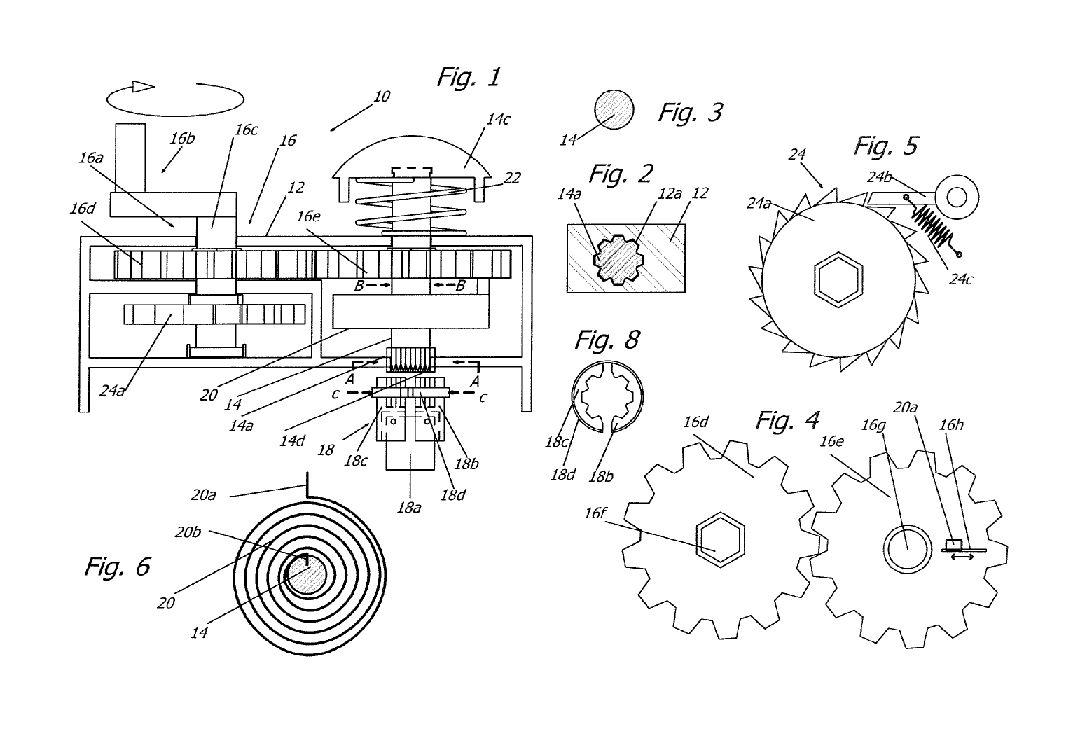

The starter unit 10 illustrated in FIG. 1 comprises a housing 12 in which a starter shaft 14, a transmission 16, a clutch 18 and a spring accumulator 20 are accommodated. The spring accumulator 20 is configured here as a spiral leaf spring (see FIG. 6).

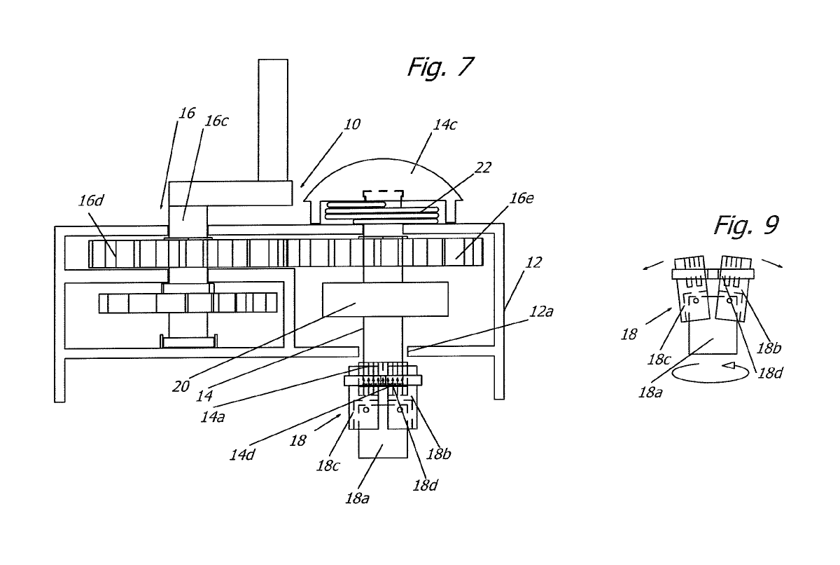

The spring accumulator 20 acts on the starter shaft 14 in order to cause rotational movement thereof. In this variant, the starter shaft 14 is mounted in a longitudinally displaceable manner in the housing 12. In the housing 12, the starter shaft is to be brought from a disengaged idle position shown in FIG. 1 into an engaged starter position (see FIG. 7) cooperating with the clutch 18. In the disengaged idle position, the starter shaft 14 is mounted in the housing 12 in a torque proof manner. Specifically, longitudinal teeth 14a are formed on an end of the starter shaft 14 facing the clutch 18 for this purpose. These longitudinal teeth 14a are received in a correspondingly profiled through hole 12a. At its end comprising the longitudinal teeth 14a and facing away from the clutch 18, the starter shaft 14 has a diameter which is reduced relative to the longitudinal teeth 14a and is circular (see FIG. 3). This enables an unimpeded longitudinal movement and an unimpeded rotational movement of the starter shaft 14 relative to the housing 12 once the starter shaft 14 has been brought from the disengaged idle position into the engaged starter position.

The transmission 16 has a crank handle 16b on its input side 16a. This crank handle 16b is connected to an input shaft 16c in a torque proof manner. The input shaft 16c carries a first gear wheel 16d meshing with a second gear wheel 16e. The first gear wheel 16d is arranged on the input shaft 16c in a torque proof manner. In the illustrated variant, the first gear wheel 16d is provided with a hexagonal central opening 16f matching with the correspondingly shaped input shaft 16c in a torque proof manner. The second gear wheel 16e has a circular central opening 16g by means of which the second gear wheel 16e is rotatably accommodated on the starter shaft 14 (see FIG. 4). The spiral spring accumulator 20 also surrounds the starter shaft 14. An outer end 20a of the spring accumulator 20 is coupled to the transmission 16, more specifically to the second gear wheel 16e of the transmission 16, due the fact that the outer end 20a of the spring accumulator 20 is received in a radial slot 16h in the second gear wheel 16e in a radially displaceable manner. The other, inner end 20b of the spring accumulator 20 is firmly connected to the starter shaft 14 (see FIG. 6). A rotational movement of the crank handle 16b is transmitted via the two gear wheels 16d and 16e to the spring accumulator in such a manner that the outer end 20a of the spring accumulator 20 is wound up, since the inner end 20b of the spring accumulator 20 is fastened to the starter shaft 14 mounted in a torque proof manner. Due to the above described arrangement of the starter shaft 14, which is fixed in a torque proof manner in its disengaged idle position, the spring accumulator 20 can be charged.

The starter shaft 14 is arranged displaceable in its longitudinal direction in the housing 12 so that it can be brought from the disengaged idle position into the engaged starter position by means of a longitudinal movement to be manually applied to the starter shaft 14 along the longitudinal axis thereof.

In its engaged starter position, the longitudinal teeth 14a of the starter shaft 14 engage with a complimentarily shaped receiving means 18b, 18c of the clutch 18. In the presently illustrated variant, the longitudinal teeth 14a have tooth ends 14d tapering towards the front face. This facilitates engagement of the longitudinal teeth 14a of the starter shaft 14 in the complementarily shaped receiving means 18b, 18c of the clutch 18 in each angular position of the starter shaft 14 relative to the complementarily shaped receiving means 18a of the clutch 18.

In this embodiment, the starter shaft 14, the transmission and the clutch 18 are arranged such that, when the starter shaft 14 is engaged in the engaged starter position, the starter shaft 14 is released from its torque-proof mounting 12a only after the starter shaft 14 has been engaged with the receiving means 18b, 18c of the clutch 18.

When the starter shaft 14 is engaged in the receiving means 18b, 18c of the clutch 18, the clutch 18 transmits a rotational movement of the starter shaft 14 caused by the spring accumulator 20 to an engine shaft (not further shown here) of the internal combustion engine (not further shown here) for causing rotation thereof.

In the variant of the starter unit shown here, the clutch 18 is a centrifugal clutch. This enables the starter shaft 14 to be accommodated in the clutch 18 in a torque proof manner when the starter shaft 14 is engaged in the starter position. When a rotational movement is applied to the centrifugal clutch by the internal combustion engine at a predetermined rotational speed, for example the idle speed of the internal combustion engine, the centrifugal clutch again releases the starter shaft 14. Specifically, the clutch 18 is provided with a central part 18a extending to the engine shaft of the internal combustion engine which is not further shown here. This central part 18a carries the receiving means 18b, 18c on its side facing the longitudinal teeth 14a of the starter shaft 14. This receiving means 18b, 18c for the longitudinal teeth 14a of the starter shaft 14 is formed of two half shells 18b, 18c. These two half shells 18b, 18c are fastened to the central part 18a in a radially deflectable manner and are held together by a tension spring ring 18d. When the engine shaft of the internal combustion engine rotates fast, i.e. has reached, for example, the idle speed of the internal combustion engine or more, the two half shells 18b, 18c pivot apart due to the centrifugal force against the tension of the tension spring ring 18d (see FIG. 8) and the clutch 18 releases the longitudinal teeth 14a of the starter shaft 14.

In the variant of the starter unit shown here, a spring arrangement 22 is provided which serves the purpose of forcing the starter shaft 14 from the engaged starter position back into the disengaged idle position. Thus, the starter shaft 14 is brought back into the torque-proof, disengaged idle position, in which the longitudinal teeth 14a of the starter shaft 14 are received in the correspondingly profiled through hole 12a so that the starter shaft 14 cannot rotate about its longitudinal axis.

In the variant of the starter unit shown here, the transmission has a transmission ratio of 1:1. Variants thereof comprise a reduction gear translating a plurality of revolutions at its input side into an at least partial rotation of the end of the spring accumulator to be coupled to the transmission.

The variant of the starter unit shown here includes a blocking device 24 in the transmission 16 which permits charging of the spring accumulator by rotating the input side of the transmission into a first direction of rotation, but prevents rotation of the input side of the transmission in a second, opposite direction of rotation. For this purpose, a blocking wheel 24a is accommodated on the input shaft 16c in a torque proof manner, which blocking wheel cooperates with a catch 24b preventing a backward rotation of the blocking wheel 24a. As shown in FIG. 5, the catch 24b engages with the blocking wheel 24a. The catch 24b is rotatably mounted and is pressed onto the blocking wheel 24a by a spring 24c attached to the housing. This specific shape of the teeth enables a smooth forward rotation of the blocking wheel 24a, but prevents backward rotation thereof.

At the end of the starter shaft 14 opposite to the longitudinal teeth 14a of the starter shaft 14, a push button 14c is provided for manual engagement in the starter position which, in the present variant, is pressed onto an annular collar of the starter shaft and is thus accommodated on the starter shaft 14 in a captive and rotatable manner.

For starting the internal combustion engine, an operator actuates the crank handle in the sense of winding up the spring accumulator. The free wheel prevents an undesired backward rotation of the crank handle and the starter shaft fixed in the idle position permits winding up of the spring accumulator. When the spring accumulator is charged, the starter shaft can be brought into the starter position in the centrifugal clutch by briefly pressing or hitting the push button, in which position the spring accumulator causes rotation of the starter shaft and thus of the internal combustion engine. Once the internal combustion engine rotates automatically and has reached its idle speed, the centrifugal clutch opens up and again releases the starter shaft. The starter shaft is returned into its idle position by the spring arrangement.

In a further variant of the starter unit, it is provided that the chargeable spring accumulator is to be coupled to the engine shaft of the internal combustion engine for charging in order to introduce energy from the running internal combustion engine into the spring accumulator. This energy will then be available for a later starting process for starting the internal combustion engine. For this purpose, a further transmission is provided which receives, on its input side, a rotational movement from the engine shaft of the internal combustion engine, and which couples, on its output side, to the spring accumulator for transmitting the rotational movement to the spring accumulator. A friction clutch for limiting the rotational movement transmitted to the spring accumulator is provided in order to prevent overstretching/overwinding of the spring accumulator. Thus, the operator is saved the effort of having to operate the handle in the next starting process of the internal combustion engine. Rather, only the already pre-tensioned spring accumulator is to be triggered. In this arrangement, the push button for triggering the pre-tensioned spring accumulator is provided with a fold-away cover for safety reasons. This fold-away cover prevents undesired triggering caused by unintentional actuation of the push button. This arrangement can also be employed with already existing rope pull systems.

The above described variants of the starter unit as well as the manufacturing and operating aspects thereof merely serve a better understanding of the structure, mode of operation and characteristics thereof; they do not limit the disclosure to the embodiments. The Figures are, in part, schematic wherein essential characteristics and effects are, in part, shown considerably enlarged for illustrating the functions, operating principles, technical configurations and features. Each mode of operation, each principle, each technical configuration and each feature disclosed in the Figures or in the text can be freely and arbitrarily combined with any one of the claims, any feature in the text and in the other Figures, other modes of operation, principles, technical configurations and features contained in this disclosure or resulting therefrom so that all conceivable combinations are to be associated with the described starter unit. This also includes combinations between any one of the individual explanations in the text, i.e. in each section of the description, in the claims as well as combinations between various variants in the text, in the claims and in the Figures.

The claims do not limit the disclosure and thus the possible combinations of any one of the illustrated features among themselves either. Here, all disclosed features are explicitly disclosed individually as well as in combination with all other features.

What is claimed is:

1. A starter unit for a device with an internal combustion engine, comprising:
a spring accumulator adapted to act on a starter shaft for causing a rotational movement of the starter shaft;
wherein the starter shaft is arranged and adapted to be brought from a disengaged idle position into an engaged starter position cooperating with a clutch; and
wherein the starter shaft is arranged such that it is mounted in a torque proof manner in the disengaged idle position and is rotatably mounted in the engaged starter position; and
a transmission which is arranged and adapted to couple, on its output side, to the spring accumulator for at least partial charging thereof;
wherein the clutch is arranged and adapted to transmit, when the starter shaft is engaged, a rotational movement of the starter shaft caused by the spring accumulator to an engine shaft of the internal combustion engine in order to cause rotation thereof, wherein the starter shaft is adapted to be brought from the disengaged idle position into the engaged starter position by means of a longitudinal movement to be applied manually, wherein the starter shaft comprises a push button, which is rotatably accommodated at an end of the starter shaft facing away from the clutch, for manual engagement in the starter position.

2. The starter unit according to claim 1, wherein the transmission is adapted to charge the spring accumulator in the disengaged idle position of the starter shaft.

3. The starter unit according to claim 1, wherein the transmission is adapted to transmit a manual rotational movement to be applied on a transmission input side to the spring accumulator for charging the spring accumulator.

4. The starter unit according to claim 1, wherein the starter shaft, the transmission and the clutch are arranged such that, when the starter shaft is engaged in the engaged starter position, the starter shaft is released from its torque-proof mounting only when the starter shaft has been engaged with the clutch.

5. The starter unit according to claim 1, wherein the clutch is a centrifugal clutch adapted to accommodate the starter shaft in a torque proof manner when the starter shaft is engaged in the starter position, and to release the starter shaft when a rotational movement is applied to the centrifugal clutch by the internal combustion engine at a predetermined rotational speed.

6. The starter unit according to claim 1, wherein the spring accumulator comprises a spiral spring, and wherein one end of the spring accumulator is to be coupled to the transmission and the other end of the spring accumulator is coupled to the starter shaft.

7. The starter unit according to claim 1, wherein a spring arrangement is provided for forcing the starter shaft from the engaged starter position back into the disengaged idle position.

8. The starter unit according to claim 1, wherein the transmission is a reduction gear which translates a plurality of revolutions on its input side into an at least partial rotation of the end of the spring accumulator to be coupled to the transmission.

9. The starter unit according to claim 1, wherein the transmission comprises a blocking device which permits charging of the spring accumulator by rotating the input side of the transmission in a first direction of rotation, but prevents rotation of the input side of the transmission in a second, opposite direction of rotation.

10. The starter unit according to claim 1, wherein the chargeable spring accumulator is to be coupled to the engine shaft of the internal combustion engine for charging in order to introduce energy from the running internal combustion engine into the spring accumulator so that this energy will be available for a later starting process for starting the internal combustion engine; wherein a transmission is arranged and adapted to receive, on its input side, a rotational movement from the engine shaft of the internal combustion engine, and to couple, on its output side, to the spring accumulator for transmitting the rotational movement to the spring accumulator; and wherein a friction clutch is arranged and adapted to limit the rotational movement to be transmitted to the spring accumulator in order to thus prevent overwinding of the spring accumulator.

11. The starter unit according to claim 1, wherein the push button for triggering the pre-tensioned spring accumulator is provided with a fold-away cover.

12. A mobile device with an internal combustion engine, such as a lawn mower or a chain saw, comprising a starter unit according to claim 1.

13. A starter unit for an internal combustion engine, comprising:
a spring accumulator adapted to be charged to accumulate potential energy;
a starter shaft adapted to receive the accumulated potential energy from the spring accumulator, the starter shaft being arranged to be moved between a first position restricting rotation of the starter shaft and a second position engaging a clutch connected to the internal combustion engine; and
a manual engagement interface adapted to allow a user to move the starter shaft from the first position to the second position,
wherein, in the second position the starter shaft is rotated through release of the accumulated potential energy of the spring accumulator.

14. The starter unit according to claim 13, wherein the manual engagement interface is further adapted to return the starter shaft to the first position from the second position when the starter shaft is disengaged from the clutch.

15. The starter unit according to claim 13, wherein the manual engagement interface includes a spring to provide a force causing movement of the starter shaft from the second position to the first position.

16. The starter unit according to claim 13, wherein the manual engagement interface is a push button.

17. The starter unit according to claim 16, wherein the push button is arranged along a longitudinal axis of the starter shaft such that pressing the push button moves the starter shaft along the longitudinal axis from the first position to the second position.

18. The starter unit according to claim 13, further comprising a housing having a shaped hole, the starter shaft being arranged to be restricted from rotation by engage the hole in a the first position.

19. The starter unit according to claim 13, further comprising a transmission arranged and adapted to couple to the spring accumulator for at least partial charging of the spring accumulator.

20. The starter unit according to claim 19, wherein the transmission includes:
a crank;
a gear; and
a catch in communication with the gear to prevent rotation of the gear in a direction, thereby preventing rotation of the crank and/or spring accumulator in the direction.
